(19) United States
(12) Patent Application Publication
(10) Pub. No.: US 2005/0284651 A1
(43) Pub. Date: Dec. 29, 2005

(54) Space structure for tidying up cables connecting to an electronic appliance

(75) Inventor: Ka-Yuen Choi, New Territories (CN)

Correspondence Address: CHARLES E. BAXLEY, ESQUIRE, 90 JOHN STREET, SUITE 309, NEW YORK, NY, 10038, US

(73) Assignee: Lite-On Technology Corp.

(21) Appl. No.: 10/999,648

(22) Filed: Nov. 29, 2004

(30) Foreign Application Priority Data
Jun. 29, 2004 (TW) TW093210227

(51) Int. Cl. H02G 3/14

(52) U.S. Cl. 174/66

(57) ABSTRACT

A space structure for tidying up cables connecting to an electronic appliance, comprising a housing, a side of the housing is provided with a panel on which a plurality of input and output ports are formed for connection of different cables, the space structure defined on the panel of the housing, and comprises: a covering plate employed to cover the side of the housing and located a distance away from the panel of the housing; and at least an opening formed between the covering plate and the panel of the housing for allowing passage of the cables.

### BACKGROUND OF THE INVENTION

1. Field of the Invention

This invention relates generally to a space structure of an electronic appliance, and more particularly to a space structure for tidying up cables connecting to an electronic appliance.

2. Description of the Prior Arts

With the development of the technology, more and more computer peripheral equipments, such as the extension module attachable to a notebook computer, the hub for receiving network cables etc., have been increasingly used. Traditionally, the computers and peripheral equipments respectively have one side panel formed with a plurality of ports for connection with cables from other devices.

With reference to FIG. 1, a computer housing 10 of the prior art is shown. The housing 10 includes a rear side panel 11 on which a plurality of input and/or output ports (I/O ports), such as universal serial bus (USB), parallel/serial ports etc, for connection with cables 12 coming from, for example, the monitor, the printer, and the keyboard are formed. Since the rear side panel 11 is provided with I/O ports and a plurality of cables 12 are connected thereto, such connections deteriorate the aesthetic appearance of the rear side of the computer housing 10. Although cable ties can be used to put these cables in order, bundles of arranged cables 12 will still be dispersed all around the rear side of the housing 10 and be in a disorganized and higgledy-piggledy condition.

With reference to FIG. 2, a rear side panel 11 of an extension module 13 attachable to a notebook computer is shown in which a plurality of cables 12 are disorderly connected to the rear panel 11. With reference to FIG. 3, it is shown that a rear side panel of a hub housing 14 is provided with I/O ports and a plurality of cables 12 are connected thereto, and such connections deteriorate the aesthetic appearance of the rear side of the hub housing 14.

Therefore, there is the need for a space structure for tidying up cables connected to an electrical appliance and for enhancing the aesthetic appearance of the appliance with cables connected thereto.

### SUMMARY OF THE INVENTION

In light of the above, the present invention provides a space structure for tidying up cables connecting to an electronic appliance, which is capable of enhancing the aesthetic appearance of the electronic appliance.

The space structure in accordance with one preferred embodiment of the invention for tidying up cables connecting to an electronic appliance having a housing comprises:

a covering plate for covering one side of the housing on which a plurality of I/O ports are formed for connection with the cables, the covering plate is located at a distance from the side of the housing; and

at least one opening formed between the covering plate and the side of the housing for the cables to pass therethrough.

The present invention will become more apparent from the following description when taken in connection with the accompanying drawings, which show, for purpose of illustrations only, the preferred embodiments in accordance with the present invention.

### BRIEF DESCRIPTION OF THE DRAWINGS

FIG. 1 shows a rear side panel of a conventional computer to which a plurality of cables are connected;

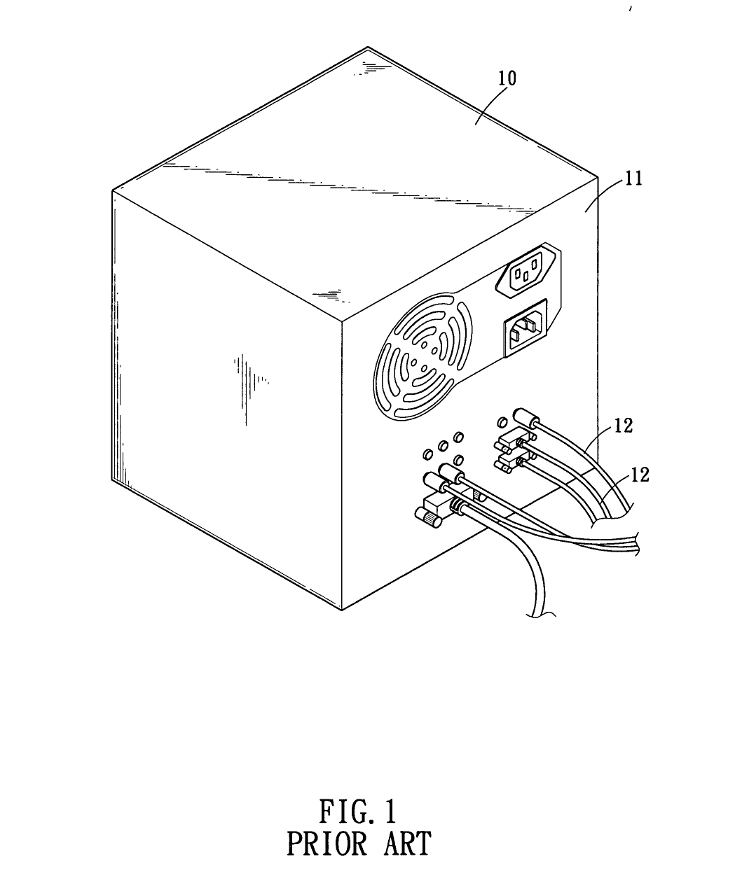

FIG. 2 shows a conventional extension device of a notebook to which a plurality of cables are connected;

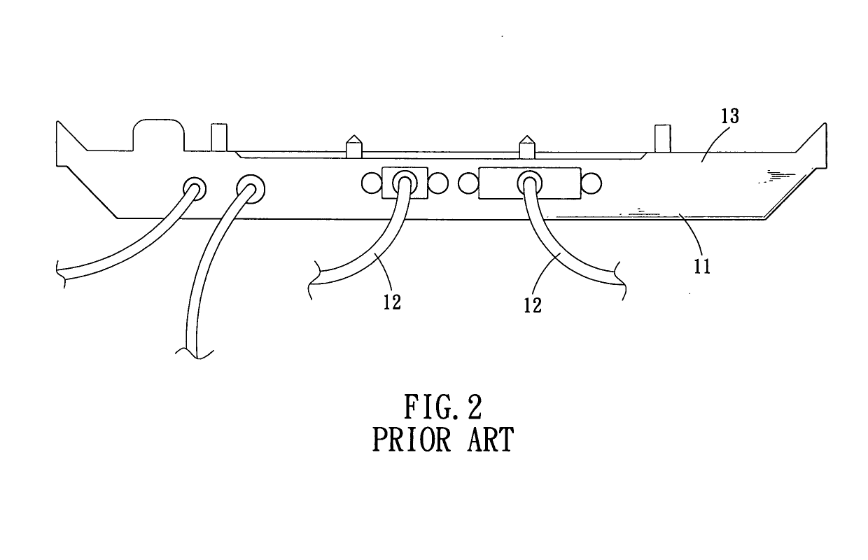

FIG. 3 shows a conventional hub to which a plurality of cables are connected;

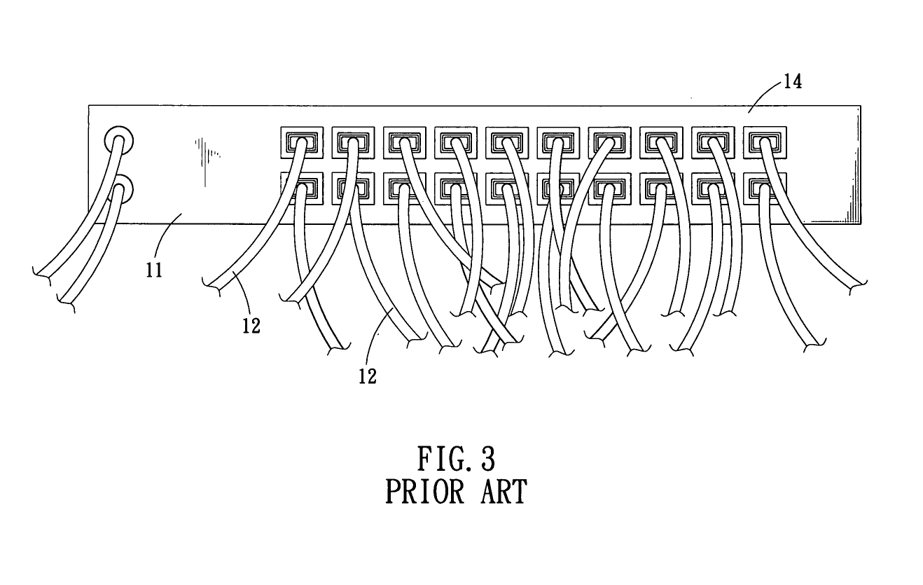

FIG. 4 is an exploded view of a space structure for tidying up cables connecting to an electronic appliance in accordance with a first embodiment of the present invention;

FIG. 5 is a side view of the space structure shown in FIG. 4;

FIG. 6 is an exploded view of a space structure for tidying up cables connecting to an electronic appliance in accordance with a second embodiment of the present invention;

FIG. 7 is a side view of the space structure shown in FIG. 6;

FIG. 8 is an exploded view of a space structure for tidying up cables connecting to an electronic appliance in accordance with a third embodiment of the present invention;

FIG. 9 is assembly side view of a space structure for tidying up cables connecting to an electronic appliance in accordance with the third embodiment of the present invention;

FIG. 10 is assembly side view of a space structure for tidying up cables connecting to an electronic appliance in accordance with a fourth embodiment of the present invention;

FIG. 11 is assembly side view of a space structure for tidying up cables connecting to an electronic appliance in accordance with the fourth embodiment of the present invention.

### DETAILED DESCRIPTION OF THE PREFERRED EMBODIMENTS

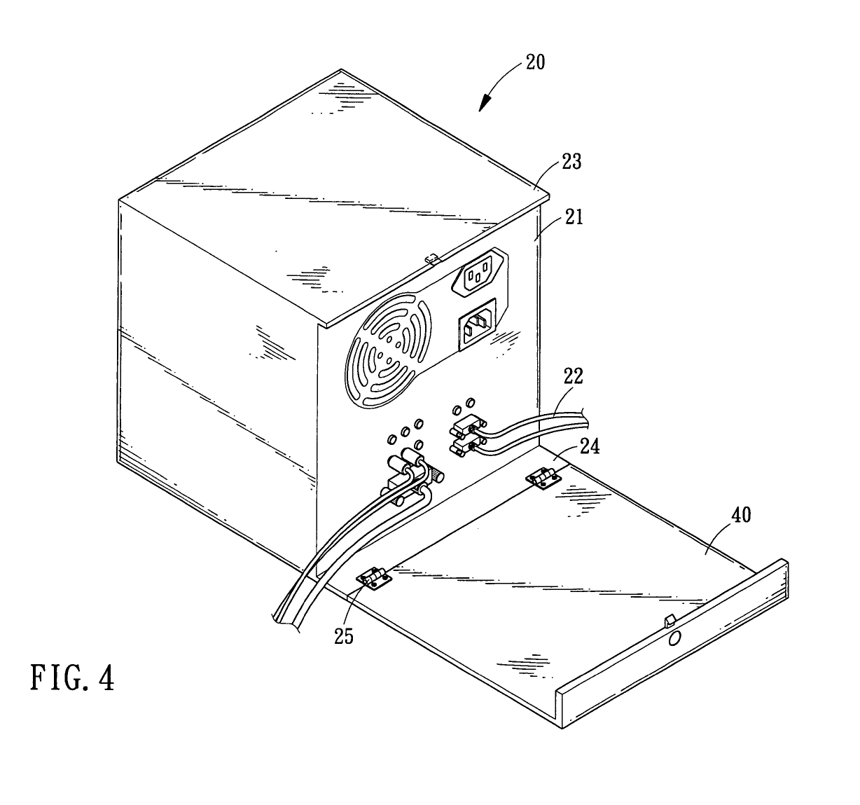

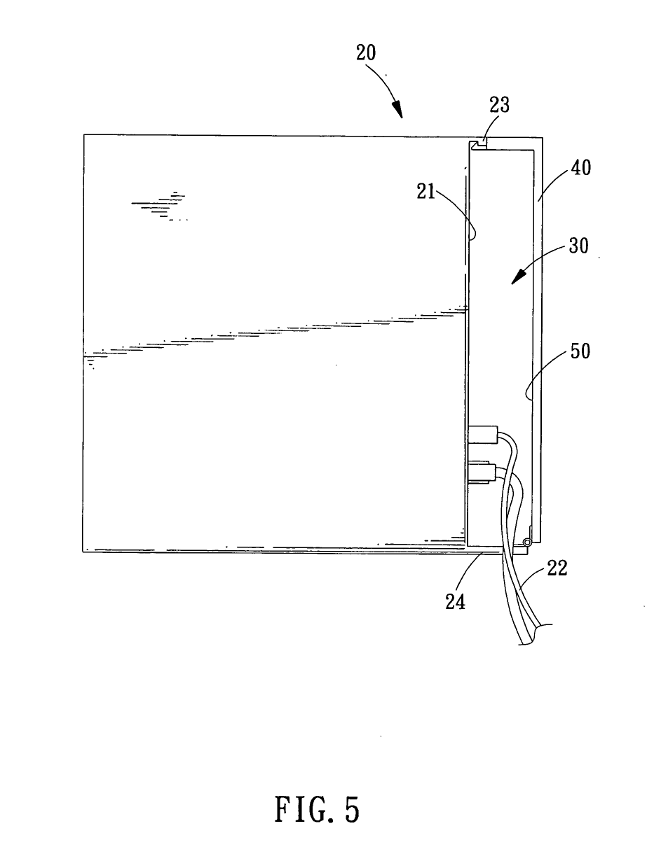

Referring to FIGS. 4 and 5, a space structure for tidying up cables connecting to an electronic appliance in accordance with a first embodiment of the present invention is shown. A rear side panel 21 of a computer housing 20 is provided with a plurality of input/output ports, such as USB, parallel/serial ports etc., for connection with cables 22 from monitor, printer, keyboard etc. A space structure 30 is defined by an upper wing plate 23, a lower wing plate 24, a covering plate 40 and two openings 50, and located on the rear panel 21.

The upper and the lower wing plates 23, 24 are provided at both sides of the rear panel 21 project therefrom.

The covering plate 40 is moveably arranged between the end of the upper and the lower wing plates 23, 24 and is located a certain distance away from the rear panel 21.

The two openings 50 are formed between the covering plate 40 and the rear panel 21, so that the cables 22 can be inserted in the space structure 30 through the openings 50.

Since the space structure 30 is located at the rear panel 21 of the housing 20, the covering plate 40 is able to cover the rear panel 21, namely, the I/O ports and the cables 22 on the rear panel 21 can be covered by the covering plate 21. Thus, improving the aesthetic appearance of the housing 20.

It will be noted that the covering plate 40 is moveably disposed between the upper and the lower wing plates 23, 24 in such a manner that a side of the covering plate 40 is pivotally fixed to the lower wing plate 24 through hinges 25 and another side of the covering plate 40 is fixed to the upper wing plate 23 through a fastener or a magnet.

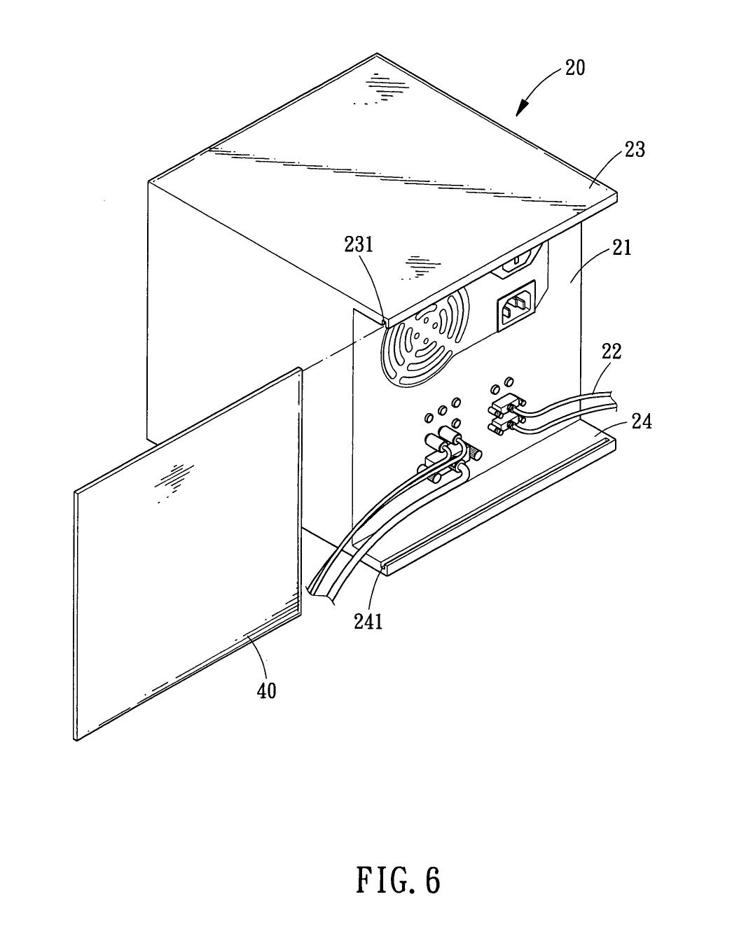

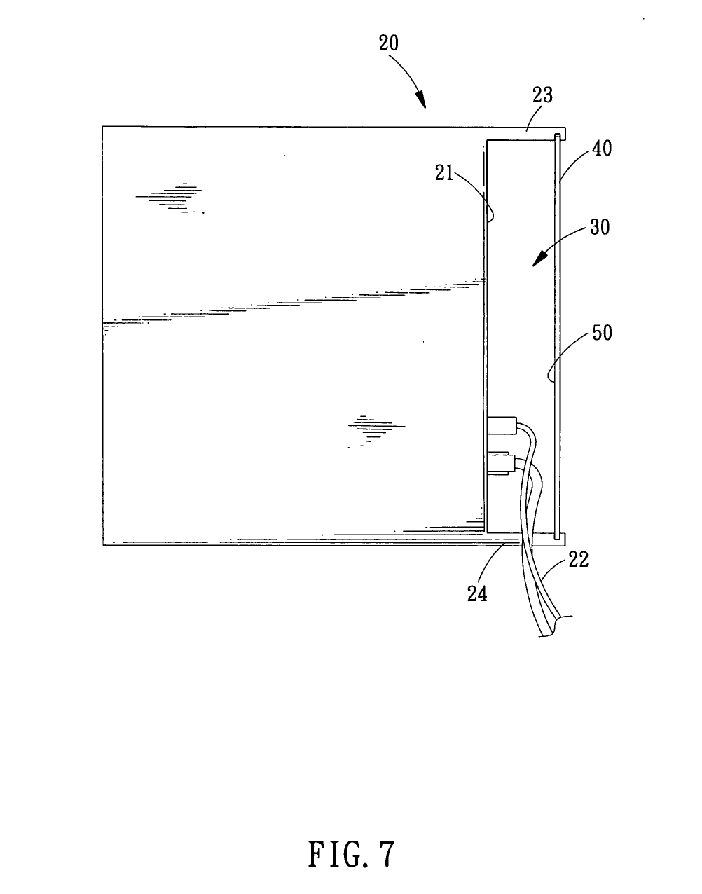

Referring to FIGS. 6 and 7, the covering plate 40 also can be inserted between the upper and the lower wing plates 23, 24 and used to cover the rear panel 21. For example, the upper and the lower wing plates 23, 24 are formed with grooves 231 and 241, respectively, so that the covering plate 40 is laterally inserted in the grooves 231 and 241.

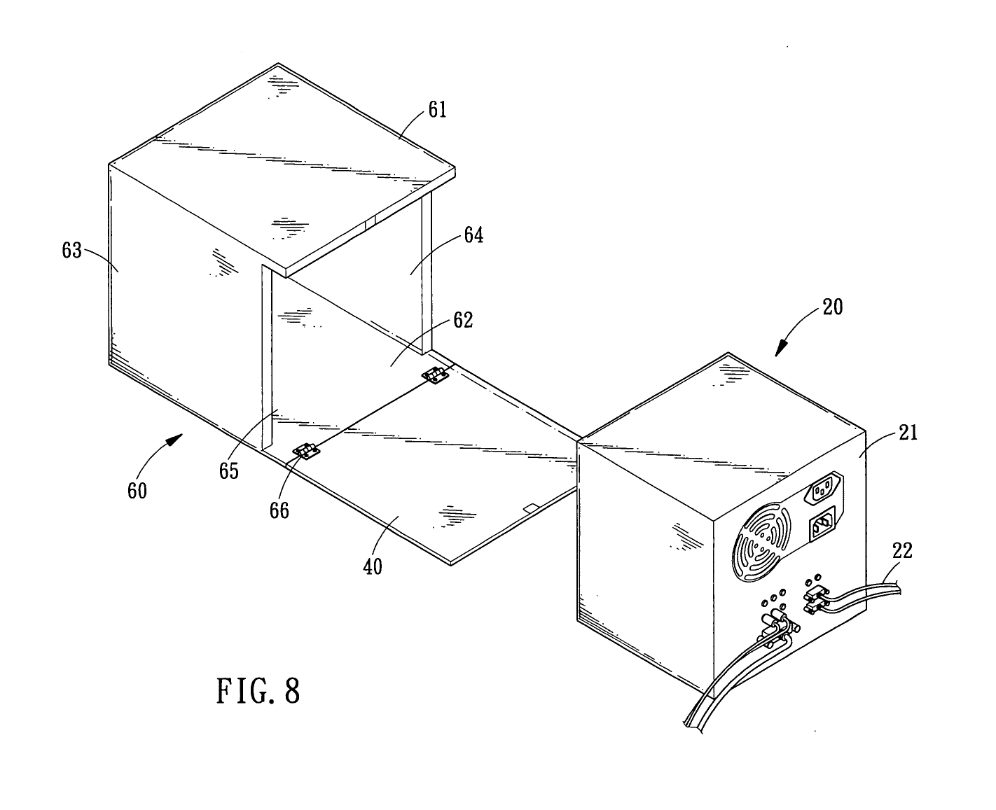

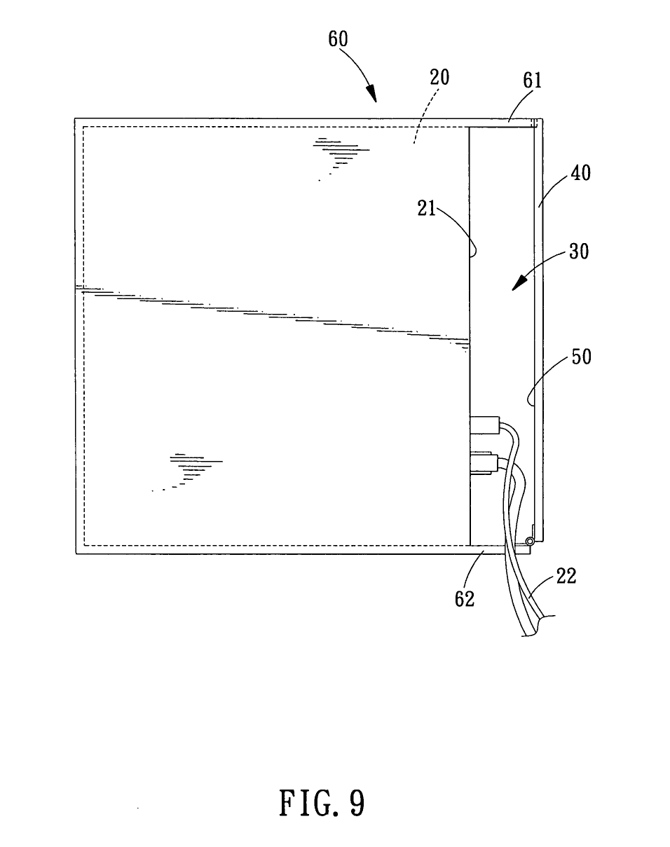

Referring to FIGS. 8 and 9, which show a space structure for tidying up cables connecting to an electronic appliance in accordance with a third embodiment of the present invention. A rear panel 21 of the housing 20 is provided with a plurality of input/output ports, such as USB, parallel/serial ports etc, for connection with different cables 22. A space structure 30, defined by an outer frame 60, a covering plate 40 and two openings 50, is located on the rear panel 21.

The outer frame 60 is formed by four plates and provided for accommodation of the housing 20. The rear panel 21 of the housing 20 is located a certain distance away from the end portion of the outer frame 60. The upper plate 61 and the lower plate 62 partially protrude out of the left and the right plates 63, 64, so as to define a gap 65 therebetween.

The covering plate 40 is moveably assembled to an end of the lower plate 62 and located a certain distance away from the rear panel 21.

The two openings 50 are formed by the gap 65 and the covering plate 40. In short, the openings 50 are formed between the covering plate 40 and the rear panel 21 for allowing the cables 22 to be inserted in the space structure 30.

Thus, the space structure 30 is formed on the rear panel 21 by the covering plate 40. Since the function of the space structure 30 in this embodiment is the same as that of the first embodiment, further explanations will be omitted.

It will be noted that a side of the covering plate 40 is moveably connected to the lower plate 62 through hinges 66 and another side of the covering plate 40 can be fixed to the upper wing plate 23 through a fastener or a magnet.

In addition, the covering plate 40 also can be inserted between the upper and the lower plates 61, 62 to cover the rear panel 21. For example, the upper and the lower wing plates 23, 24 can be formed with grooves, and the covering plate 40 is laterally inserted in the grooves.

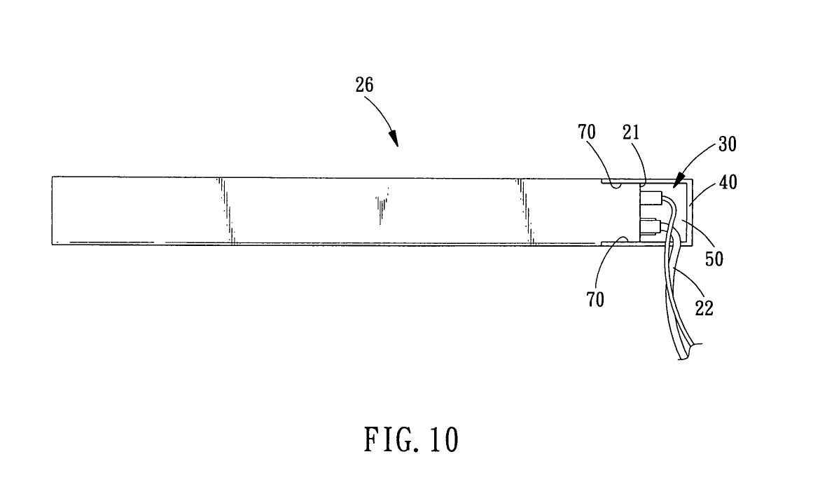

Referring to FIG. 10, a space structure for tidying up cables connecting to an electronic appliance in accordance with a fourth embodiment of the present invention is a notebook housing for example. A rear panel 21 of the housing 20 is provided with a plurality of I/O ports, such as USB, parallel/serial ports etc, for connection with different cables 22. A space structure 30 including two gaps 70, a covering plate 40 and two openings 50, is defined on the rear panel 21.

The two gaps 70 are formed at two opposite sides of the rear panel 21.

The covering plate 40 is inserted between the two gaps 70 and is located a certain distance away from the rear panel 21.

The two openings 50 are formed between the covering plate 40 and the rear panel 21.

Thus, the space structure 30 and the two openings 50 are formed on the rear panel 21 by the covering plate 40. The openings 50 are formed between the covering plate 40 and the rear panel 21 for allowing the cables 22 to be inserted in the space structure 30. Since the function of the space structure 30 in this embodiment is the same as that of the first embodiment, further explanations will be omitted.

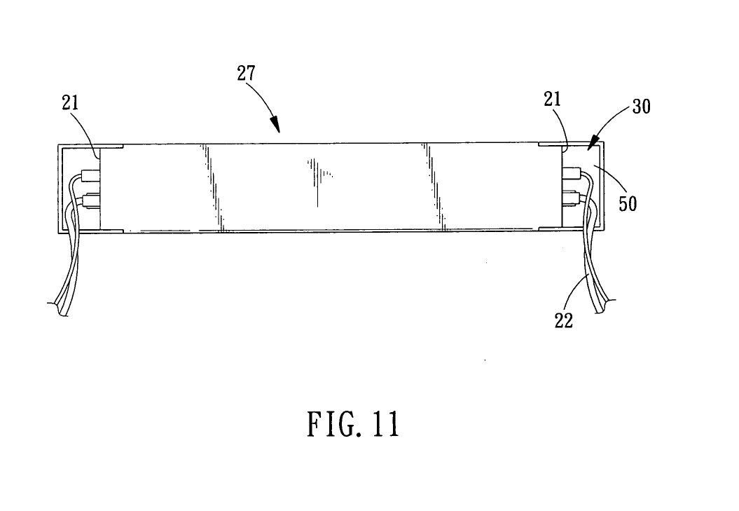

Furthermore, in this embodiment, as shown in FIG. 11, the housing 20 also can be a hub 27 for receiving network cables. The only difference is that the hub 27 itself is provided with two opposite rear panels 21 for connection with cables.

While we have shown and described various embodiments in accordance with the present invention, it should be clear to those skilled in the art that further embodiments may be made without departing from the scope of the present invention.

1. A space structure for tidying up cables connecting to an electronic appliance, comprising a housing, a side of the housing provided with a panel on which a plurality of input and output ports are formed for connection of different cables, the space structure defined on the panel of the housing, and comprising:
a covering plate employed to cover the side of the housing and located a distance away from the panel of the housing; and
at least an opening formed between the covering plate and the panel of the housing for allowing passage of the cables.

2. The space structure for tidying up cables connecting to an electronic appliance as claimed in claim 1, wherein two wing plates are provided at opposite sides of the panel of the housing and project therefrom, the covering plate is disposed between the two wing plates.

3. The space structure for tidying up cables connecting to an electronic appliance as claimed in claim 2, wherein the covering plate is rotatably assembled to the two wing plates, and employed to cover the panel of the housing.

4. The space structure for tidying up cables connecting to an electronic appliance as claimed in claim 2, wherein the covering plate is inserted between the two wing plates and employed to cover the panel of the housing.

5. The space structure for tidying up cables connecting to an electronic appliance as claimed in claim 1, wherein the panel is formed in an outer frame and located a distance away from an end of the outer frame, the covering plate is disposed at the end of the outer frame.

6. The space structure for tidying up cables connecting to an electronic appliance as claimed in claim 5, wherein the covering plate is rotatably assembled to the end of the outer frame, and serves to cover the panel of the housing.

7. The space structure for tidying up cables connecting to an electronic appliance as claimed in claim 5, wherein the covering plate is inserted in the outer frame and serves to cover the panel of the housing.

8. A space structure for tidying up cables connecting to an electronic appliance, comprising a housing, a side of the housing provided with a panel on which a plurality of input and output ports are formed for connection of different cables, the space structure defined on the side of the housing, and comprising:
two wing plates connected to two opposite sides of the panel and project therefrom;
a covering plate disposed between the two wing plates and located a distance away from the panel of the housing; and
at least an opening formed between the covering plate and the panel of the housing for allowing passage of the cables.

9. The space structure for tidying up cables connecting to an electronic appliance as claimed in claim 8, wherein the covering plate is rotatably assembled to the end of the outer frame, and serves to cover the panel of the housing.

10. The space structure for tidying up cables connecting to an electronic appliance as claimed in claim 8, wherein the covering plate is inserted in the outer frame and serves to cover the panel of the housing.

11. A space structure for tidying up cables connecting to an electronic appliance, comprising a housing, a side of the housing provided with a panel on which a plurality of input and output ports are formed for connection of different cables, the space structure defined on the panel of the housing, and comprising:
an outer frame provided for accommodation of the housing and located a distance away from the panel of the housing;
a covering plate moveably disposed at an end portion of the outer frame and employed to cover the panel of the housing; and
at least an opening formed between the covering plate and the panel of the housing for allowing passage of the cables.

12. The space structure for tidying up cables connecting to an electronic appliance as claimed in claim 11, wherein the covering plate is rotatably assembled to the end of the outer frame, and serves to cover the panel of the housing.

13. The space structure for tidying up cables connecting to an electronic appliance as claimed in claim 11, wherein the covering plate is inserted in the outer frame and serves to cover the panel of the housing.

14. A space structure for tidying up cables connecting to an electronic appliance, comprising a housing, a side of the housing provided with a panel on which a plurality of input and output ports are formed for connection of different cables, the space structure defined on the panel of the housing, and comprising:
two gaps formed at two opposite sides of the panel of the housing;
a covering plate inserted in the two gaps and located a distance away from the panel of the housing; and
at least an opening formed between the covering plate and the panel of the housing for allowing passage of the cables.
